(19) United States
(12) Patent Application Publication
(10) Pub. No.: US 2025/0221399 A1
(43) Pub. Date: Jul. 10, 2025

(54) PROCESSES AND SYSTEMS FOR ANIMAL TRAINING AND/OR PREVENTING DESTRUCTION OF YARD ITEMS

(71) Applicant: Paige PORTER, Spring, TX (US)

(72) Inventor: Paige PORTER, Spring, TX (US)

(21) Appl. No.: 18/905,605

(22) Filed: Oct. 3, 2024

Related U.S. Application Data
(63) Continuation-in-part of application No. 18/409,049, filed on Jan. 10, 2024, now abandoned.

(51) Int. Cl. A01M 29/30

(52) U.S. Cl. CPC A01M 29/30

(57) ABSTRACT

Systems and methods for protecting a yard item from damage from an animal are disclosed. A representative system comprises a yard item such as a sprinkler head subject to potential damage from an animal and a detector configured to detect the presence of an animal in the vicinity of the yard item and transmit a signal to a protection device. The protection device is operably connected to the detector and configured to protect the yard item upon receipt of a transmitted signal from the detector. In some embodiments the protection device is a barrier to at least partially enclose said the yard item. The protection device is configured (1) to move as the animal moves to prevent the animal from accessing said the yard item; or (2) to move as the yard item moves to prevent the animal from accessing said the yard item; or (3) both (1) and (2).

### CROSS-REFERENCE TO RELATED APPLICATIONS

The present application is a continuation-in-part of U.S. Ser. No. 18/409,049 filed on Jan. 10, 2024 which application is incorporated herein by reference.

### FIELD OF THE DISCLOSURE

The present disclosure relates to processes and systems for animal training and preventing destruction of, for example, sprinklers, yard lights, and other outdoor accessories.

### BACKGROUND AND SUMMARY

Wild animals and even domestic pets such as dogs and cats are sometimes prone to destroy certain fixtures and other items in an outdoor and/or an indoor environment-particularly when an animal is unsupervised by a human. Accordingly, what is needed are training methods, devices, and systems, as well as methods and systems of preventing destruction or harm to items exposed to animals.

Advantageously, the instant application pertains to new training methods, devices, and systems, as well as methods and systems of preventing destruction or harm to items exposed to animals.

In one embodiment, the application pertains to a system for protecting a yard item from damage from an animal. The system comprises a yard item subject to potential damage from an animal. A detector is configured to detect the presence of an animal in the vicinity of the yard item and transmit a signal to a protection device. The protection device is operably connected to the detector and configured to protect the yard item upon receipt of a transmitted signal from the detector.

In another embodiment the application pertains to a system for protecting a yard item from damage from an animal comprising a yard item subject to potential damage from an animal. A detector is configured to detect the presence of an animal in the vicinity of the yard item and transmit a signal to a protection device. A protection device is operably connected to the detector and configured to protect the yard item upon receipt of a transmitted signal from the detector. The protection device is a barrier to at least partially enclose said yard item. The protection device is configured (1) to move as the animal moves to prevent the animal from accessing said yard item; or (2) to move as the yard item moves to prevent the animal from accessing said yard item; or (3) both (1) and (2).

In another embodiment the application pertains to a sprinkler system comprising a sprinkler head comprising a movable nozzle subject to potential damage from an animal. A detector is configured to detect the presence of an animal in the vicinity of the movable nozzle subject to potential damage from an animal. The detector is configured to transmit a signal to a protection device upon the detection of an animal in the vicinity of the movable nozzle subject to potential damage. The protection device is configured to at least partially enclose the sprinkler head comprising the movable nozzle such that the sprinkler head is protected from potential damage.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 shows a representative system of the claimed invention.

FIG. 2 shows a rotary sprinkler protected by a rotating barrier.

FIG. 3A shows a representative fencing design to surround a rotary sprinkler or other device to be protected

FIG. 3B shows a representative fencing design to surround a rotary sprinkler or other device to be protected

FIG. 3C shows a representative fencing design to surround a rotary sprinkler or other device to be protected.

### DETAILED DESCRIPTION

The following description of embodiments provides a non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The systems and methods disclosed herein generally relate to new training methods, devices, and systems, as well as methods and systems of preventing destruction or harm to items exposed to animals. More particularly, the systems and methods described herein pertain to protecting yard items such as sprinklers, new plants, and other items at risk from either wild animals or untrained pets from destruction. Moreover, training methods and systems are disclosed which can be used as an alternative or in addition to the protection systems and methods.

In one embodiment, the application pertains to a system for protecting one or more yard items from damage from an animal. The system comprises a yard item subject to potential damage from an animal. The types of yard items useful herein are not particularly limited and may include any common or uncommon yard items that may be subject to damage from a pet, e.g., domestic dog or cat, and/or a wild animal, e.g., feral cat, rabbit, deer, squirrel, chipmunk, raccoon, armadillo, skunk, fox, etc.

Typical yard items include such items as sprinkler heads configured to sprinkle water for irrigation (pop-up, spray, rotary, risers, pop-up rotary, etc.), lights configured to provide light for decoration, security or other purposes (landscape lights with cords or cordless, spot lights, flood lights, step lights, low voltage, post, etc.), decorations (seasonal or otherwise, e.g., a blow-up Santa Claus), plants, or even gardens comprising plants, shrubs or trees.

Typically, one or more detectors, i.e., sensors, is configured to detect the presence of an animal or other threat to the yard item wherein the animal or other threat is approaching and/or in the vicinity of the yard item in need of protection. The type of detector may be selected based on the item to be protected, the type of protection device, other system components, and/or other factors. Typical detectors may include, for example, a video sensor, an audio sensor, a microwave sensor, a vibration motion sensor, an ultrasonic motion sensor, a reflective motion sensor, or any combination thereof. The one or more detectors may be a passive motion detector, an active motion detector, an infrared radiation detector, or any combination thereof of the aforementioned sensors/detectors.

The location of the detector may be in any convenient location which location may be based on the type of detector, the yard item in need of protection, the type of animal or threat to be detected, and the specific protection device to be employed. In some embodiments the detector may be integrated into the yard item. That is, a sprinkler head or light may comprise the detector.

In some embodiments the one or more detectors may be located adjacent the yard item to be protected. In some embodiments the one or more detectors may be remote from the one or more yard items but configured to be pointed at the one or more yard items to detect movement and/or the presence of a threat to the yard item. In still other embodiments to provide increased protection, there may be a combination of detectors that are integral to the one or more yard items, adjacent the one or more yard items, and/or remote from the one or more yard items. In this manner the one or more sensors can provide a 360 degree of protection that may also include a combination of audio, video, vibration, motion, and/or heat sensor protection.

The one or more detectors, i.e., sensors, are further configured to transmit a signal to one or more protection devices upon detection of the presence of an animal or other threat to the yard item. The type of signal transmission may depend upon the detector and the protection device. In some cases the type of signal transmission is not particularly critical so long as the protection device is notified of the potential threat. Thus, the signal transmission may be wireless, wired, or any combination thereof.

The protection device is operably connected to the detector and configured to protect the yard item upon receipt of a transmitted signal from the detector. The one or more protection devices may protect the yard item in one or more manners which manner may vary depending upon the yard item, threat, and other aspects of the systems or processes.

In some embodiments the one or more protection devices may be configured to protect the yard item from the animal or other threat upon receipt of a transmitted signal from the detector in one or more different ways or responses. For example, the one or more protection devices may be configured to (a) spray a chemical or physical deterrent toward the animal; (b) emit an auditory deterrent signal toward the animal; (c) emit a deterrent video signal toward the animal; (d) physically protect said yard item; (e) reward the animal for not damaging the yard item; (f) shock the animal for attempting to damage the yard item; or (e) any combination thereof.

The manner that the protection device protects the yard item may vary depending upon the yard item to be protected and the animal or threat from which it needs protection. In some embodiments the one or more protection devices may include all of the aforementioned manners to protect the yard item and be operably connected to a processor.

The processor operably linked to said detector and protection device may be configured to track a number a number and type of transmitted signals from said detector, a number and type of protections for the yard item upon receipt of transmitted signals from said detector, or any combination thereof. In this manner the processor may provide a signal for an appropriate protection mechanism or mechanisms based on the detected threat.

The processor may be configured to select the appropriate response or responses depending upon the signal from the detector as to the nature of the threat to the yard item. That is, depending upon the type of animal detected the processor may send a different signal to the protection device for a response. For a detected animal that is better deterred by a chemical or physical or auditory or visual deterrent, then the processor may send a signal to the protection device to implement the appropriate deterrent. On the other hand, for a detected animal that may be trained such as a domestic animal, then the processor may signal a shock and/or reward as a training tool. Additionally or alternatively, the processor may in appropriate circumstances signal the protection device to physically protect said yard item by, for example, partially enclosing said yard item to protect it from damage from the animal and/or other threat.

The partial enclosing of one or more items may be conducted in any convenient manner which may vary depending upon the animal, yard item, and other factors. In some embodiments a partial enclosing may involve employing a fence, a hedge, a deterrent, or any combination thereof. Such enclosing may be stationary or in some embodiments may be configured to 1) to move as the animal moves to prevent the animal from accessing said yard item; or (2) to move as the yard item moves to prevent the animal from accessing said yard item; or (3) both (1) and (2).

For example, if the yard item is a sprinkler head that moves in a manner to sprinkle a yard from a nozzle then the protection device may be configured to at least partially enclose said sprinkler head or other yard item to be protected. Thus, the protection device may move with the sprinkler head such that the nozzle is not enclosed by said protection device as the sprinkler head moves but the rest of the sprinkler head is protected by the partial enclosing or protection device. In this manner the rotating or moving nozzle sprinkles the grass without substantial and/or any interference from the partial enclosing of the protection device. The animal will not generally interfere with the water stream from a pop-up, rotating sprinkler because it does not want to get wet and the rest of the sprinkler head other than the nozzle is protected on all sides and perhaps on the top by a protection device such as moving fence that or barrier that is employed as the sprinkler head pops up to operate.

In another embodiment the application pertains to a sprinkler system. The system comprises a sprinkler head comprising a movable nozzle subject to potential damage from an animal. The movable nozzle may be a pop-up rotating or oscillating head. A detector such as those described above may be configured to detect the presence of an animal in the vicinity of the movable nozzle subject to potential damage from an animal. The detector is configured in a convenient manner to transmit a signal to a protection device upon the detection of an animal in the vicinity of the movable nozzle subject to potential damage. When an animal is detected in the vicinity of the movable nozzle subject to potential damage the protection device is configured to at least partially enclose the sprinkler head comprising the movable nozzle such that the sprinkler head is protected from potential damage. In some embodiments the movable nozzle and the protection device are configured to move together such that a spray from the movable nozzle is not inhibited by the protection device. That is, the protection device may move so at so enclose the sprinkler head thereby protecting the nozzle from potential damage from the animal

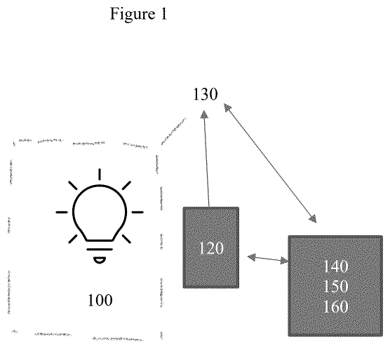

In FIG. 1 a yard item 100 in need of protection from an animal is shown. The yard item 100 may be, for example, a sprinkler head (oscillating or fixed) or any type of yard light in need of protection. A first detector 120 is configured to detect the presence of an animal in the vicinity of the yard item and transmit a signal to a protection device 130. The protection device 130 is operably connected to the first detector 120 and configured to protect the yard item upon receipt of a transmitted signal from the first detector. If desired, a second detector 140 comprising a video sensor 150 operably linked to a processor 160 which is operably linked to the first detector 120, the protection device 130, and the video sensor 150.

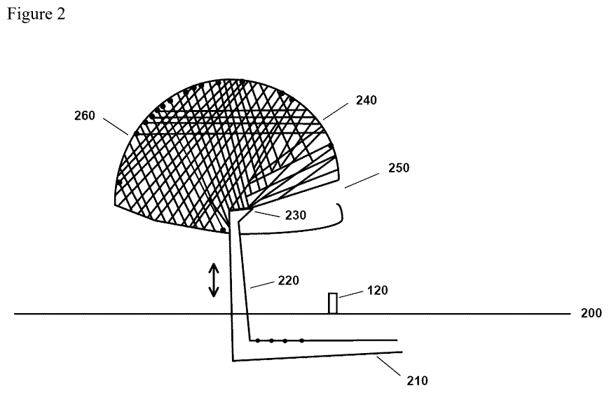

FIG. 2 shows a system for protecting a yard item from damage from an animal. The pop-up sprinkler and/or the moving barrier in FIG. 2 is operably connected to detector 120. The detector 120 is configured to detect the presence of an animal in the vicinity of the sprinkler and transmit a signal to the sprinkler, the moving barrier, or both to activate. An underground pipe 210 connects a water source (not shown) with a pop-up sprinkler 220 with rotating nozzle 230 which is generally just above the ground or at ground level before pop-up upon activation upon a signal from the detector 120 detecting an animal in the vicinity or manual activation. A rotating barrier such as a moving fence 240 is attached to the rotating nozzle 230 such that 240 rotates as rotating nozzle 230 rotates. Alternatively, the rotating barrier 240 may be attached to the non-rotating portion of the sprinkler post and have a separate motor (not shown) to rotate it at the same speed as the rotating nozzle.

The rotating barrier or moving fence 240 encloses and thereby protects the sprinkler on all sides including the top (except for the movable nozzle which is not inhibited from spraying due to opening 250 which is a sufficient opening to only allow the sprinkler to spray without spraying the rotating barrier or moving fence 240). In this manner the moving fence protects the sprinkler from damage from potential damage from an animal by rotatably spraying water in one direction while the sprinkler is enclosed and thereby protected on all other sides. While FIG. 2 shows the bottom of rotating barrier 240 at about the height of nozzle, the bottom could extend further down to protect the sprinkler post so long as opening 250 is sufficiently open so as not to inhibit the spraying. The rotating barrier may or may not electrified to provide a slight, non-lethal shock to an animal that tries to breach it.

The rotating barrier or moving fence 240 may be hinged at one or more places such as at 260 such that there is a foldable frame with a flexible fencing material attached thereto. In this manner the rotating barrier or moving fence 240 may lay flat on the ground and upon the pop-up of sprinkler the hinged, flat rotating barrier expands with the hinges locking in place and forming the protective enclosure-similar to an umbrella opening around and over the pop-up sprinkler upon sprinkler activation. Similarly, the hinges may be configured to unlock as the pop-up sprinkler retracts into the ground. Additionally or alternatively, the sensor 120 may send a signal that causes the hinge 260 to unlock and causes the pop-up sprinkler to retract so that the pop-up sprinkler goes back into the ground while the barrier 240 folds back flat. The protective enclosure 240 may be in any shape so long as it protects the sprinkler by fully enclosing it while allowing the rotating nozzle to spray unimpeded by the moving fence 240.

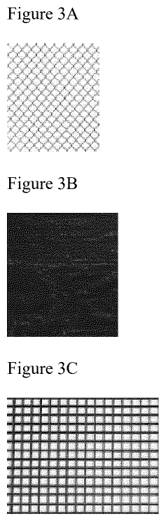

The material and geometry of the moving fence 240 may vary depending upon the type of animal it is protecting against, the landscape, and/or climate in the place of installation. In some embodiments the fence is made of a metal frame such as galvanized steel or aluminum and comprises fencing such as that shown in FIG. 3A or FIG. 3C attached around the metal frame (hinged or unhinged). Alternatively, a solid fencing type material may be attached such as a flexible plastic barrier shown in FIG. 3B. Similarly, the geometry or shape of the moving fence 240 may be semi-spherical, rectangular, square, or any other shape so long as it protects the sprinkler by fully enclosing it while allowing the rotating nozzle to spray unimpeded by the moving fence 240.

### Embodiments

1. A system for protecting a yard item from damage from an animal comprising:
a yard item subject to potential damage from an animal;
a first detector configured to detect the presence of an animal in the vicinity of the yard item and transmit a signal to a protection device;
a protection device operably connected to the first detector and configured to protect the yard item upon receipt of a transmitted signal from the first detector.
   2. The system of embodiment 1 which further comprises a second detector which comprises a video sensor operably linked to a processor;
wherein the processor is operably linked to the first detector, the protection device, and the video sensor;
wherein the processor is configured to receive the transmitted signal from the first detector and transmit a signal to the video sensor to record video and send the video to the processor; and
wherein the processor is configured to determine the specific type of animal that is in the vicinity of the yard item, determine the type of deterrent to protect the yard item from the animal, and order the first detector to send the signal to the protection device to protect the yard item using the determined type of deterrent.
   3. The system of embodiment 1 wherein the protection device is configured to protect the yard item from the animal upon receipt of a transmitted signal from the first detector by (a) spraying a chemical deterrent toward the animal; (b) emitting an auditory deterrent signal toward the animal; (c) emitting a deterrent video signal toward the animal; (d) physically protecting said yard item; (e) rewarding the animal for not damaging the yard item; (f) shocking the animal for attempting to damage the yard item; or (e) any combination thereof.
   4. The system of embodiment 1 wherein the first detector is a passive motion detector or an active motion detector.
   5. The system of embodiment 4 wherein the first detector is an infrared radiation detector.
   6. The system of embodiment 4 wherein the first detector is a video sensor, an audio sensor, a microwave sensor, a vibration motion sensor, an ultrasonic motion sensor, a reflective motion sensor, or any combination thereof.
   7. The system of embodiment 1 wherein the protection device is configured to protect the yard item from the animal upon receipt of a transmitted signal from the first detector by physically protecting said yard item by at least partially enclosing said yard item in a manner sufficient to protect the yard item from the animal.
   8. The system of embodiment 7 wherein said partial enclosing comprises a fence, a hedge, a deterrent, or any combination thereof.
   9. The system of embodiment 1 wherein the yard item is one or more sprinkler heads configured to sprinkle water.
   10. The system of embodiment 1 wherein the yard item is one or more yard lights configured to provide light.
   11. The system of embodiment 1 wherein the yard item is one or more sprinkler heads configured to sprinkle water and wherein the protection device is configured to protect the yard item from the animal upon receipt of a transmitted signal from the first detector by physically protecting said yard item by at least partially enclosing said yard item in a manner sufficient to protect the yard item from the animal.
   12. The system of embodiment 1 wherein the yard item is one or more yard lights configured to provide light and wherein the protection device is configured to protect the yard item from the animal upon receipt of a transmitted signal from the first detector by physically protecting said yard item by at least partially enclosing said yard item in a manner sufficient to protect the yard item from the animal.
   13. The system of embodiment 1 wherein the system further comprises a processor operably linked to said first detector and protection device and configured to track a number and type of transmitted signals from said detector, a number and type of protections for the yard item upon receipt of transmitted signals from said first detector, or any combination thereof.
   14. The system of embodiment 1 wherein the protection device is configured to protect the yard item from the animal upon receipt of a transmitted signal from the detector by physically protecting said yard item wherein the detector is a video sensor, an audio sensor, microwave sensor, a vibration motion sensor, an ultrasonic motion sensor, a reflective motion sensor, or any combination thereof and wherein the protection device is configured to protect the yard item from the animal upon receipt of a transmitted signal from the detector by physically protecting said yard item by at least partially enclosing said yard item in a manner sufficient to protect the yard item from the animal.
   15. A system for protecting a yard item from damage from an animal comprising:
a yard item subject to potential damage from an animal;
a detector configured to detect the presence of an animal in the vicinity of the yard item and transmit a signal to a protection device; and
a protection device operably connected to the detector and configured to protect the yard item upon receipt of a transmitted signal from the detector;
   wherein the protection device is a barrier to at least partially enclose said yard item and wherein the protection device is configured:
   (1) to move as the animal moves to prevent the animal from accessing said yard item; or
   (2) to move as the yard item moves to prevent the animal from accessing said yard item; or
   (3) both (1) and (2).
   16. The system of embodiment 15 wherein the yard item is a sprinkler head that moves in a manner to sprinkle a yard from a nozzle and wherein the protection device at least partially encloses said sprinkler head such that the nozzle is not enclosed by said protection device as the sprinkler head moves.
   17. A sprinkler system comprising
a sprinkler head comprising at least one movable nozzle subject to potential damage from an animal; and
a detector configured to detect the presence of an animal in the vicinity of the movable nozzle subject to potential damage from an animal wherein the detector is configured to transmit a signal to a protection device upon the detection of an animal in the vicinity of the movable nozzle subject to potential damage;
wherein the protection device is configured to at least partially enclose the sprinkler head comprising the movable nozzle such that the sprinkler head is protected from potential damage.
   18. The sprinkler system of embodiment 17 wherein the movable nozzle and the protection device are configured to move together such that a spray from the movable nozzle is not inhibited by the protection device and the protection device moves so at so enclose the sprinkler head thereby protecting the nozzle from potential damage from the animal.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A system for protecting a sprinkler from damage from an animal comprising:
a sprinkler comprising a rotary nozzle to sprinkle a yard with water;
a first detector configured to detect the presence of an animal in the vicinity of the sprinkler and transmit a signal to the sprinkler to activate the sprinkler; and
a moving fence attached to the rotary nozzle to at least partially enclose the sprinkler and wherein the moving fence moves with the rotary nozzle to enclose and protect the rotary sprinkler on all sides other than the nozzle.

2. The system of claim 1 which further comprises a second detector which comprises a video sensor operably linked to a processor;
wherein the processor is operably linked to the first detector, the sprinkler, and the video sensor;
wherein the processor is configured to receive the transmitted signal from the first detector and transmit a signal to the video sensor to record video and send the video to the processor for storing.

3. The system of claim 1 wherein the first detector is a passive motion detector or an active motion detector.

4. The system of claim 1 wherein the first detector is an infrared radiation detector.

5. The system of claim 1 wherein the rotary nozzle moves to sprinkle a yard comprising grass with water without the moving fence deflecting water such as to interfere with sprinkling.

6. The system of claim 1 wherein the sprinkler comprising the rotary nozzle to sprinkle the yard with water comprises a pop-up sprinkler with the rotary nozzle proximate to ground level.

7. The system of claim 6 wherein the moving fence is attached to the rotary nozzle such that the moving fence rotates as the rotary nozzle rotates while sprinkling.

8. The system of claim 6 wherein the moving fence comprises a woven mesh with openings.

9. The system of claim 7 wherein the moving fence is hinged at one or more places such that there is a foldable frame with a flexible fencing material attached thereto.

10. The system of claim 8 wherein the moving fence is hinged at one or more places such that there is a foldable frame with the woven mesh with openings attached thereto.
